(19) United States
(12) Patent Application Publication
(10) Pub. No.: US 2004/0213883 A1
(43) Pub. Date: Oct. 28, 2004

(54) Dough that browns, raises and forms an oven tender bread crust under the influence of microwave incident energy

(76) Inventors: Nagwa Zaki Sadek, Ypsilanti, MI (US); Mohamed M. Morad, Marshall, MN (US); Mark Elliot Ingelin, Marshall, MN (US)

Correspondence Address: MERCHANT & GOULD PC, P.O. BOX 2903, MINNEAPOLIS, MN, 55402-0903, US

(21) Appl. No.: 10/423,038

(22) Filed: Apr. 24, 2003

(51) Int. Cl. A21D 10/00

(52) U.S. Cl. 426/549

(57) ABSTRACT

A dough that can bake to form a bread product having a homebaked taste, aroma, freshness, attractive browned character and pleasing crispness of a homemade bread. The product can be obtained by baking the dough in a microwave oven without the time, bother and mess of preparing a leavened dough and baking the dough in a thermal or convection oven. The product can include bread products including breads rolls, etc. The invention relates to a crust that can be combined with a topping or filling to form a baked product. Such products include such items as a pizza, meat pie, fruit pie etc. suitable for baking in a microwave oven. The crust has a unique formulation that ensures a high quality product. Further, the unique formulation provides a crust that forms a well-raised, attractive browned crust even in combination with substantial quantities of fillings having large amounts of water and other components. The crust, combined with an appropriately sized susceptor layer, can be heated in a microwave to result in a crust containing food that is substantially equivalent to freshly made crusts.

### FIELD OF THE INVENTION

The invention relates to dough that can be heated, cooked, raised and browned by incident microwave energy in a microwave oven or combination convection microwave oven. More particularly, the invention relates to dough that can achieve home-baked characteristics in a baked bread product having a crispy crust and a tender bready interior from microwave cooking. The product provides taste, aroma, freshness, browned character, crust crispness and tender bready characteristic of home-baked products without the time, bother and mess of developing yeast leavened dough and baking the product in a thermal oven. The dough of the invention can be used in bread products such as breads, rolls, pretzel and other such products typically comprising a cooked bready product. Further, the dough of the invention can be used in the manufacture of filled items such as pizza, calzone, fruit pie, potpie, etc. In such filled items, the crust that can contain a sweet or savory filling such as a pizza filling, a meat filling or pie filling that when cooked in a microwave oven obtains an attractive browned appearance and a fully raised, soft tender bready texture with a crisp crust characteristic.

### BACKGROUND OF THE INVENTION

Frozen, bake at home bread products have been developed over the years. These products were initially expressly developed for baking in thermal ovens and could not be cooked in microwave ovens. These products were initially adapted to bready products such as bread loaves, rolls, sweet rolls and related products. Further, some frozen crusts have been made available for pizza manufacture but have been formulated and designed solely for cooking in thermal ovens. While these products have had some success in the marketplace, a strong desire has existed for many years for microwave-able dough products that cook in a microwave oven to a fully acceptable form equivalent to that made by thermal processes. To date, no frozen bread product has been available for microwave cooking, with or without a microwave susceptor that achieves quality results in a bread roll, pretzel, etc. Similarly, in more complex products such as pizzas, fruit pies, meat pies and other products, no truly successful product has been made that can be cooked in a microwave to result in a quality bread product.

The vast majority of frozen pizzas designed for microwave energy heating have comprised foods made by forming a topping on a pre-baked crust. Such foods are typically configured for reheating in a microwave oven such that the partially baked (par-baked) crust is returned to a semblance of the baked crust as it was freshly made prior to freezing. Such a par-baked, ready to heat and eat crusts are well known and have been available for many years. These foods, when reheated, do not substantially change in the nature of the size or thickness of the crust, do not obtain any substantial chemical or yeast driven leavening of the crust, typically do not change the bready texture of the crust and do not typically result in substantial browning characteristics in the reheating of the product.

A small proportion of crusts have been intended for baking in microwave ovens for the purpose of causing the yeast or chemically leavened crust to raise, bake and brown when heated by incident energy in the oven. In microwave baking, the energy tends to heat the periphery to an extent greater than the interior. As a result, if the center is cooked fully, the edges tend to be overcooked and toughened. This toughening is especially evident following extended counter-top time. The prior art has attempted to deal with this problem in a number of ways. In certain pizzas, the crust is colored with a dye material to match the color of the crust to a browned crust. In other crust materials, a specifically designed susceptor structure has been developed in order to attempt controlled heating of the pizza material. In still other patents, specific formulations have been developed that contain ingredients that were intended to increase the palatability of the crust over prior art materials. Examples of this are Ottenberg, U.S. Pat. No. 4,463,020 and Furcsik et al., U.S. Pat. No. 5,260,076, disclose a crust including a novel starch material. Kwis et al., U.S. Pat. No. 4,917,907, teach a crust combining sugar, an amino acid source such as a whey solid, a dough conditioner and a leavening agent to provide a useful crust. Such products, in order to obtain a browned, fully cooked material; often tend to result in a toughened, dried exterior crust with reduced bready characteristics that is considered less desirable to the consuming public. These results are obtained from overcooking, substantial moisture loss, failure to achieve adequate dough raise, and substantial protein denaturation.

We believe, even with the previously available offerings and in consideration of the disclosures of the prior art that we have reviewed, that no successful offering has been made that reaches a sufficient quality in the crust to satisfy the demands of the marketplace. No offering, that we have reviewed, combines, in a microwaveable crust, the characteristics of a fully baked, fully raised, tender, bready and browned crust layer that can be made without microwave induced toughening of the crust material. We believe a substantial need exists in the art to produce a frozen dough, in the presence of substantial amounts of topping or filling ingredients, can be heated in a microwave oven to result in a raised, bready, browned, high quality pizza crust that combines both crispness and tenderness in the crust.

### BRIEF DISCUSSION OF THE INVENTION

We have found dough that can be baked in a microwave oven to yield a crisp crust with a soft, moist interior having about 30-60 wt % water after baking. The crispness and softness of the resulting crust is characterized by its measured texture as discussed below. The peak force of penetrating the crust and the force for penetrating the bready character define the crispness and softness of the dough, while the slope of and area under the penetration curve provides additional information regarding the degree of crispness of the dough. We have found that such dough can be made by at least two formulations involving different aspects of dough manufacture. The dough can be used to form any bread product having a crispy crust and a bready interior.

The dough can be cooked, without toughening, into a crust having an appealing crispy crust and a soft tender interior. We have found dough that can be made from a unique formulation that when heated in a microwave oven, can raise, form a bready crust, brown and fully cook into a tender attractive crust. The dough comprises a yeast leavened aqueous mixture comprising a major proportion of flour, about 25 to 75 wt % water, about 0.5 to 10 or 1 to 5 wt % of an emulsifier, and about 0.5 to 10 or 1 to 5 wt % of cheese or cheese equivalent (the percentages based on flour). We have also found a formulation that combines a unique chemical leavening system and a dough additive mixture that results in dough that can raise and for a bready character and after cooking result in a crispy, bready character in a tender attractive crust. The dough formulations of the invention can be cooked on an appropriate susceptor or can be cooked without susceptor in a microwave or thermal oven. We have also found a dough formulation that combines, in a yeast leavened dough, a particular chemical leavening system and an additive package comprising edible fiber, soluble fiber, cellulose, cellulosic fibers or related cellulosic-like gum materials combined with controlled moisture content and fat content.

The unique formulations used in preparing the dough materials can be baked into a crust using one or two preferred methods. In a first method, the mixed and rested dough is sheeted, docked, cut to the appropriate form, proofed, frozen, topped and baked. In this process, the dough, during cooking, expands substantially to form a fully baked, bready, but crispy dough with controlled moisture content. In an alternative method, the dough can be blended into workable dough, formed into dough balls, pressed into a rough crust form using high temperature pressing technology, proofed or raised, frozen and topped with pizza toppings, the frozen dough can then be baked in a microwave oven to form the quality material of the invention.

We have found that formulations and methods achieve a quality crust. By maintaining high moisture level in the dough, emulsifying the dough with a substantially increased level of emulsifier and combining the cheese with the dough permits the dough to bake uniformly from the deepest part of the center through to the periphery, uniformly while maintaining substantial amounts of water without drying in any aspect of the crust. We believe the aqueous portion of the dough, the emulsifier, the fat and the cheese components, cooperate in the dough matrix. We have found that the cooperation between the chemical leavening ingredients, the fiber/cellulosic additive package, the fat, moisture and other components cooperate, in the dough matrix, to produce a dough that rises and bakes to a bready, crispy nature.

We have also found a similar formulation that can contain a proportion of a solid, semi-solid or liquid fat that cooperates with the cheese to improve the dough during cooking. We have also found a similar formulation that can contain a natural sweetener such as sugar that acts as a humectant to help maintain water content. Further, we have also found useful formulations that can contain a chemical leavening agent such as sodium bicarbonate or an active baking powder for effective leavening purposes. The baking powder can comprise either a single action or a double action material.

The final product comprises uniform high moisture content, a soft bready character and the exterior crispness. The dough of the invention resists the toughening characteristic of previous microwave dough since the dough does not become overly dry, denatured, or consolidated. We have found that these formulations and ingredients, when cooked in a microwave oven, on an appropriately sized susceptor, obtains a controlled uniform cooking of center to edge, retains moisture, obtain crispness with a tender bready interior without immediate or delayed toughening. The formation and process results in a high quality, crisp, bready, tender crust. These crust attributes can be measured using equipment that measures the physical force and rates needed to penetrate the crust and bread. Another criterion for a quality crust is extent of crust rising. This crust is 2 to 8 or 3 to 6 mm when sheeted and proofed into the dough form and expands or increases at a ratio of 1:2 to 1:8 or 1:5 of initial thickness to cooked thickness when baked into a finished crust that is at least 1 cm, 1 to 2.7 or 1 to 3 cm or larger in cooked thickness. Lastly, the moisture content of the formulated dough is about 35 to 50 wt. % and the moisture content of the final baked bread or crust is about 25 to 35 wt.-%.

One important embodiment of the bread and dough of the invention is the use of the compositions and methods of the invention to form a pizza crust for pizza manufacture. The dough provides, to a raw dough, frozen pizza, a pizza that can be thawed, placed in a microwave oven and quickly baked into a microwave to rise product that has a highly desirable, high quality crust having a crispy exterior, a bready interior without microwave toughening. The pizza crust of the invention made from the bready formulations and methods, can be formulated, combined with pizza ingredients and frozen. The frozen pizza can be distributed to consumers who can then rapidly cook the frozen pizza into a baked product having a highly attractive crust that has a crispy exterior, a bready interior in the substantial absence of any microwave toughening. The crust can be alternatively cooked in a microwave with or without a susceptor or in a thermal oven or in a combination thermal microwave oven to rapidly form the desirable product.

For the purpose of this patent application, the term “crisp” indicates a dough that has a crust characteristic such that the dough, when measured for penetration using a Texture analyzer machine, has a rapidly rising force curve, measured by the high slope of the curve, reaches a failure plateau quickly and fails rapidly to a level that indicates a tender bready interior. The term “tender” in this disclosure refers to a dough penetration measurement of the bready character at a level less than about 3000, about 1250 to 3000 grams just after baking. After a period of time the crust can increase in penetration force by as much as 50%. The term “toughness” indicates that a substantial amount of force is required over an extended period, a low slope of the penetration curve, to penetrate the dough and that, once penetrated; the dough does not fail and return to a low penetration level. The term “natural sweetener” typically refers to sweeteners such as that obtained from natural sources. However, such sweeteners can be augmented with artificial sweetener components.

### BRIEF DESCRIPTION OF THE DRAWINGS

FIG. 1 is a view of an uncooked docked dough portion that can be used as a pizza crust once cooked.

FIGS. 2 and 2a shows the uncooked crust of FIG. 1 with sauce and cheese toppings placed on a susceptor surface. FIG. 2a is a cross section of the uncooked, topped pizza.

FIG. 3 shows a fully cooked pizza with a raised, browned, expanded crust with a crispy exterior and a cooked cheese and filling topping.

FIG. 4 shows the underside of the pizza of FIG. 3 demonstrating the browned, cooked, crispy character of the underlying surface.

FIG. 5 shows a preferred susceptor structure that can, when used with an appropriate microwave power, results in a high quality pizza crust from the dough of the invention.

FIG. 6 is a graphical representation of the crust lip and interior crumb physical properties.

FIG. 7 is a graphical representation of the crust physical properties of an example of the invention compared to a preparation of a crust without the ingredients that maintain desirable crust properties.

### DETAILED DISCUSSION OF THE INVENTION

The improved dough of the invention can be used to bake products into the form of breads, rolls, pretzels and other bready products and to make other more complex products such as pies, pizzas, calzones, etc. The dough of the invention can be baked in a microwave oven, with or without a susceptor, and in thermal ovens or combination microwave or thermal ovens to form a moist, bready product having a crispy exterior crust. The crispiness and tenderness of the crust and bread are characterized by its texture characteristics as measured in the patent and discussed below. Complex products using the dough of the invention including pies and pizzas are a preferred embodiment of the invention. The dough can be converted into a pizza crust using sheeting or hot pressing methods, frozen and distributed for consumption. The complex products such as a pie or a pizza can be thawed and baked into a high quality product rapidly using microwave technology.

The pizza crust of the invention, prepared from any of the disclosed formulations, obtains a crisp exterior and a light bready interior with substantially no microwave toughening out of the oven, or after extended counter-top time, from the formula and the processing of the dough materials. The crust of the invention typically is made from a dough formula that has increased and controlled moisture content. The moisture control obtains a quality crust. Moisture control can be achieved using careful formulation techniques. In one formulation, a yeast-leavened dough is combined with substantial quantities of a food grade emulsifier and a cheese or cheese equivalent. In one embodiment of the invention, the formulation is further combined with an appropriate controlled sugar and oil content. The moisture, emulsifier and low oil and sugar content provide improved texture and appearance after baking. In another embodiment, a useful formulation comprises a chemical leavening agent such as sodium bicarbonate or an active baking powder for effective leavening purposes. The baking powder can comprise either a single action or a double action material. We have found still another formulation that in a chemically leavened formulation combines fiber/cellulosic materials and a source of a food grade gum to form quality dough.

The tenderness, crispness and toughness of a cooked, baked crust can be measured using texture analyzer equipment. The equipment can quantify the tenderness, crispness or toughness of a crust in units of gm (grams), gm-sec⁻¹ (grams per second) and gm-sec (gram seconds) by an analysis of the forces exerted by a probe. Tenderness typically is a measure of the force required to penetrate the product with the machine probe, but mimics the force needed to bite through the product. Crispness is a measurement of the steepness slope of the force curve (Force Gradient in gm-sec) needed to penetrate the crust. In other words, as the crispy crust is bitten, the slope of the penetration curve is very steep, greater than 300 gm-sec⁻¹ or 550 gm-sec⁻¹, reaches a failure point very quickly, but fails at a relatively defined level. A less crispy crust will have a less steep curve that reaches a lesser maximum. The area under the force curve (Area of Force Curve in gm-sec) indicates that a great deal of force, greater than 8000 gm-sec) is needed typically shows toughness in a crust. This indicates that a great deal of time and force is required to chew (penetrate) tough dough. A tender dough is typically less than 5500 gm-sec. (particularly at some time, +20 minutes, after baking), or less than 3000 gm-sec. within 5 minutes of baking.

In measuring these crusts characteristics, the equipment is TA.XT2 Texture analyzer. The equipment can be obtained from Stable Micro System Company and is available for crust evaluations in a variety of product configurations and dough formulations. Food scientists have known for many years that it is difficult to obtain both crispness and tenderness in the same product without substantial toughening in a microwave cooked offering. We have found that the borderline between toughness and tenderness is about 3000 g measured within 5 minutes after the conclusion of baking. Greater than 3000 g, in some dough, 20 minutes or more after baking, greater than 4500 g., indicates a substantially toughened dough, while substantially less than 3000 g indicates clear, tender dough character. A secondary measurement of toughness is the area under the force curve. It can be readily understood that, as the area under the force curve increases, that the force required to penetrate and continue penetrating the baked crust stays high with increasing area. Accordingly, a large area under the force curve, typically greater than 6500 gm-sec. or greater than 8000 gm-sec. indicates a toughened crust. Either the overall force gradient of the curve measured from the initiation of force on the crust to peak force or by measuring the slope of the force curve at or just before penetration, provides a characterization of crust crispness. We have found that an overall force gradient, measured within 5 minutes of baking, greater than about 300 gm-sec⁻¹ in the overall gradient or greater than about 550 gm-sec⁻¹ near peak force is indicative of a crispy crust. This crispiness must be combined with a measurement of deftness to indicate a quality crust. This measurement also, in conjunction with a crisp measurement, indicates the high quality dough required in the invention. To date, the dough that is formulated for microwave oven cooking, all have tenderness values substantially greater than 3000 gm and are noticeably tough on eating.

One other characteristic of the dough of the invention is the extent that the dough raises upon cooking. Much prior microwave dough, if cooked in a microwave oven, can have some degree of raising. However, the degree of raising is limited and often the dough can collapse somewhat as toughening, dehydration and overcooking sets in. The dough of our invention initially range from about 3 to 6 millimeters when sheeted, proofed and frozen before topping, but upon cooking in a microwave oven, reach a thickness of at least 10 millimeters and as much as 25 millimeters. This change in dimension results in a ratio of initial thickness:final thickness of about 1:2 to about 1:5 or 1:8 or more. Prior art rising dough tend to be, in a final product, less than 1:2. The premium dough of the invention contains a specific controlled proportion of yeast leavened flour, oil, emulsifier, cheese, natural sweetener and chemical leavening as discussed above.

Such sugars can comprise sucrose, fructose, glucose, high fructose corn syrup, or other sweet mono- or disaccharides commonly used in baking materials. Such sugars can comprise sucrose, fructose, glucose, high fructose corn syrup, or other sweet mono- or disaccharides commonly used in baking materials. The amount of moisture used in the pizza dough materials is more than the amount required to form the dough into a workable dough mass. The amount of moisture used in making the dough results in a first blended dough having a substantial consistency. The water content of the dough is typically maintained in the dough during initial mixing and processing. The dough can be floured or crumbed with breadcrumbs to improve process ability and dough quality after baking.

The natural sweetener can be augmented with artificial sweetener materials. However, a substantial proportion of the sweetener must be a natural sweetener that contains substantial proportions of a polyol character such as sucrose, glucose, high fructose, corn syrup and related materials. The highly hydrophilic nature of the polyol character of the sugar acts as a humectant that can cooperate with the high levels of emulsifier and liquid oil to maintain the uniform high moisture content characteristic of the dough of the invention. The amount of moisture used in the pizza dough materials is more than the amount required to form the dough into a workable dough mass. The water content of the dough is typically maintained in the dough during initial mixing and processing. The dough can be floured or crumbed with breadcrumbs to improve process-ability and dough quality after baking.

The premium dough of the invention uses a yeast leavened dough, typically made by combining about 100 parts by weight of wheat flour with about 1 part of yeast, typically in an instant active creamy aqueous form. That yeast leavened flour is combined with water, emulsifier and cheese to create a formula that can maintain uniform, high levels of moisture content in a crispy crust, covering a soft bready dough having little or no microwave toughening.

The food grade or food additive emulsifier material used in the crust is an ingredient that cooperates with the flour, moisture, cheese and other components to maintain a quality crust. Typical emulsifier use in most baked bread product is substantially less than 1% and commonly is used in amounts of about 0.1 to about 0.5 wt %. In the formulations of the invention, the emulsifier is used at concentrations greater than 1% and typically in the range of about 1 to 10 wt.-% or about 2 to 5-wt %. The substantially increased amount of emulsifier, dispersed throughout the dough, maintains moisture content and reduces the tendency of the dough to dry and toughen upon cooking.

Known acceptable food grade or food additive emulsifier materials include: Acacia; Acetylated hydrogenated coconut glycerides; Acetylated hydrogenated cottonseed glyceride; Acetylated hydrogenated soybean oil glyceride; Acetylated lard glyceride; Acetylated mono- and diglycerides of fatty acids; Acetylated tartaric acid esters of mono- and diglycerides of fatty acids; Acyl lactylates; Agar; Albumen; Algin; Alginic acid; Aluminum caprylate; Aluminum stearate; Ammonium alginate; Ammonium carrageenan; Ammonium furcelleran; Ammonium phosphate, dibasic; Arabinogalactan; Ascorbyl palmitate; Bakers yeast extract; Bentonite Calcium carrageenan; Calcium citrate; Calcium dihydrogen pyrophosphate; Calcium furcelleran; Calcium lactate; Calcium phosphate monobasic monohydrate; Calcium phosphate tribasic; Calcium/sodium stearoyl lactylate; Calcium stearate; Calcium stearoyl lactylate; Canola oil glyceride; Capric triglyceride; Caprylic/capric triglyceride; Capryllic triglyceride; Carrageenan; Cellulose; Cholesterol; Cholic acid; Coconut oil; Corn glycerides; Corn oil; Cottonseed glyceride; Cottonseed oil; Damer; Diacetyl tartaric acid esters of mono-and diglycerides; Disodium citrate; Disodium phosphate, dihydrate; Disodium pyrophosphate; Furcelleran; Guar gum Gum ghelti; Hydrogenated cottonseed glyceride; Hydrogenated lard glyceride; Hydrogenated lard glycerides; Hydrogenated palm glyceride; Hydrogenated rapeseed oil; Hydrogenated soybean glycerides; Hydrogenated soy glyceride; Hydrogenated tallow glyceride; Hydrogenated tallow glyceride citrate; Hydrogenated tallow glyceride lactate; Hydrogenated tallow glycerides; Hydrogenated vegetable glyceride; Hydrogenated vegetable glycerides; Hydrogenated vegetable oil. Hydroxylated lecithin; Hydroxypropylcellulose; Hydroxypropyl methylcellulose; Karaya gum; Lactic acid esters of mono-and diglycerides of fatty acids; Lactylic esters of fatty acids; Lard; Lard glyceride; Lard glycerides; Lecithin; Locust bean gum; Magnesium stearate; Methylcellulose; Methyl ethyl cellulose; Mono- and diglycerides of fatty acids; Mono- and diglycerides, sodium phosphate derives; Octenyl succinic anhydride; Oleth-23; Palm glyceride; Palm oil; Palm oil sucroglyceride; Peanut glycerides; Peanut oil; Pea protein concentrate; Pectin; PEG-20 dilaurate; PEG-7 glyceryl cocoate; PEG-20 glyceryl stearate; PEG-40 sorbitan hexataliate; PEG-20 sorbitan tritaliate; PEG-6 stearate; PEG-8 stearate; PEG-40 stearate; Pentapotassium triphosphate; Phosphatidylcholine; Polyglyceryl-10 decasterate; Polyglyceryl-10 decastearate; Polyglyceryl-2 dilsostearate; Polyglyceryl-3 dilsostearate; Polyglyceryl-5 dilsostearate; Polyglyceryl-3 dioleate; Polyglyceryl-6 dioleate; Polyglyceryl-10 dioleate; Polyglyceryl-10 dipalmitate; Polyglyceryl-2 distearate; Polyglyceryl-3 distearate; Polyglyceryl-5 distearate; Polyglyceryl-6 distearate; Polyglyceryl-10 distearate; Polyglyceryl-8 hexaoleate; Polyglyceryl-10 hexaoleate; Polyglyceryl-10 isostearate; Polyglycaryl-10 laurate; Polyglyceryl-10 linoleate; Polyglyceryl-10 myristate; Polyglyceryl-2 oleate; Polyglyceryl-3 oleate; Polyglyceryl-4 oleate; Polyglyceryl-6 oleate; Polyglyceryl-8 oleate; Polyglyceryl-4 pentaoleate; Polyglyceryl-10 pentaoleate; Polyglyceryl-4 pentastearate; Polyglyceryl polyyricinoleate; Polyglyceryl-2 sesquioleate; Polyglyceryl-2 stearate; Polyglyceryl-3 stearate; Polyglyceryl-4 stearate; Polyglyceryl-8 stearate; Polyglyceryl-10 stearate; Polyglyceryl-10 tetraoleate; Polyglyceryl-2 tetrastearate; Polyglyceryl-2 trisosterate; Polyglyceryl -4 tristearate; Polysorbate 20; Polysorbate 21, Potassium alginate; Potassium citrate; Potassium furcelleran; Potassium oleate; Potassium phosphate dibasic; Potassium phosphate tribasic; Potassium polymetaphosphate; Potassium sodium tartrate anhyd; Potassium sodium tartrate tetrahydrate; Potassium tripolyphosphate; Propylane glycol; Propylene glycol alginate; Propylene glycol dicaprylate/dicaprate; Propylene glycol esters of fatty acids; Propylene glycol laurate; Propylene glycol laurate SE; Propylane glycol monodistearate; Propylene glycol oleate; Propylene glycol oleate SE; Propylene glycol palmitate; Propylene glycol ricinoleate; Propylene glycol ricinoleate SE; Propylene glycol ricinoleate SE; Propylene glycol stearate; Propylene glycol stearate SE; Rapeseed oil glyceride; Saccharose distearate; Saccharose mono/distearate; Saccharose palmitate; Safflower glyceride; Safflower oil; Sodium acid pyrophosphate; Sodium aluminum phosphate acid; Sodium aluminum phosphate, basic; Sodium carrageenan; Sodium caseinate; Sodium furcellaran; Sodium hexametaphosphate; Sodium hypophosphite; Sodium laurate; Sodium lauryl sulfate; Sodium metaphosphate; Sodium phosphate dibasic; Sodium phosphate tribasic; Sodium phosphate tribasic dodecahydrate; Sodium stearate; Sodium stearoyl lactylate; Sodium tartrate; Sorbitan caprylate; Sorbitan myristate; Sorbitan palmitate; Sorbitan sesquioleate; Sorbitan sesquistearate; Sorbitan stearate; Sorbitan trioleate; Sorbitan tristearate; Sorbitan tritallate; Soybean oil; Soy protein; Steareth-20; Stearyl-2-lactyle acid; Succinylated monoglycerides; Succistearin; Sucrose dilaurata; Sucrose distearate; Sucrose erucate; Sucrose fatty acid esters; Sucrose laurate; Sucrose myristate; Sucrose oleate; Sucrose palmitate; Sucrose polylaurate; Sucrose polylinoleate; Sucrose polyoleate; Sucrose polystearate; Sucrose stearate; Sucrose tetrastearate triacetate; Sucrose tribehenete; Sucrose tristerate; Sunflower seed oil; Sunflower seed oil glyceride; Sunflower seed oil glycerides; Superglycerinated hydrogenated rapeseed oil; Tallow glyceride; Tallow glycerides; Tartaric acid esters of mono- and diglycerides, Tetrapotassium pyrophosphate; Tetrasodium pyrophosphate; Tragacanth gum; Triaodium citrate; Xanthan gum.

Preferred emulsifiers for use in this invention include monoglycerides, diglycerides and mixed monodiglycerides. These emulsifiers comprise fatty acid esters of glycerol in which the glycerol is substituted with one or two fatty acid moieties or mixed materials thereof. Common monoglycerides, diglycerides or mixed monoglycerides and diglycerides include the following: Glyceryl caprate; Glyceryl caprylate/caprate; Glyceryl citrate/lactate/linoleate/oleate; Glyceryl cocoate; Glyceryl cottonseed oil; Glyceryl dioleate; Glyceryl dioleste SE; Glyceryl disterate; Glyceryl distearate SE; Glyceryl d/tribehenate; Glyceryl lactoesters; Glyceryl lactoeleate; Glyceryl lactopalmitate/stearate; Glyceryl laurate; Glyceryl laurate SE; Glyceryl linoleate; Glyceryl mono/dilaurate; Glyceryl mono/dioleate; Glyceryl mono/distearate; Glyceryl mono/distearate-palmitate; Glyceryl oleate; Glyceryl oleate SE; Glyceryl palmitate; Glyceryl palmitate lactate; Glyceryl palmitate stearate; Glyceryl ricinoleate; Glyceryl ricinoleate SE; Glyceryl soyate; Glyceryl stearate; Glyceryl stearate citrate; Glyceryl state lactate; Glyceryl stearate SE.

The cheese component typically comprises a blend of dairy protein, dairy fat, moisture and some amount of mineral character in a solid or semi-solid material. The primary intent of this patent application is to use a natural cheese made from pasteurized or unpasteurized dairy sources typically converted to a cheese using conventional cheese making technologies. However, the industry has developed a number of cheese materials that are equivalent to natural cheese made by blending dairy or non-dairy protein, dairy or non-dairy fat, inorganic supplements and other food grade materials into a material that is a substantial equivalent to natural cheese. This application should not be so narrowly construed that known cheese equivalents are excluded from the scope of the invention. The percentages disclosed herein are all based on the flour content.

Cheeses used in the dough formulations can include mozzarella, Romano, Parmesan, jack and others. Commonly, cheeses in the form of shaved, crumbled or string form derived from mozzarella, Romano, Parmesan, provolone and whole milk or non-pasteurized cheeses can be used in the compositions of the invention. Cheeses, processed cheeses, cheese substitutes and cheese blends can be used both in the form of blended materials wherein two or more cheeses are blended and then applied to the crust. However, cheeses can also be added to the crust in layers without premixing.

Colorants and browning agents can also be used to enhance the attractiveness of the crusts of the invention. Products including Char SOL VSA, Maillose, both can impart a dark brown, golden brown, caramel color or tan character to a product without imparting undesirable flavors. Liquid smoke products can be used to provide browning if the smoky character of the color is not objectionable in the particular formulation. With the browning agent applied, the crust of the invention, when cooked at an appropriate microwave power setting on an appropriately shaped susceptor, obtains a pleasing crispy brown character. Conventional browning agents can aid in introducing a pleasing appearance and can help adjust the depth of color in the final crust. Conventional browning agents include sugar and amino acids react by heat developing Millard reaction which is the browning of the surface. The invention browning agent is an aqueous solution at 30 to 50% concentration.

The lipid content of the dough material can be derived from both room temperature solid fatty materials and room temperature oil materials. Solid fats can include a variety of the shortening materials available on the market, lard, butter, margarine and blended products. Oily materials are also helpful in attaining the lipid content of the dough of the invention. Such oils typically comprises vegetable oils derived from a variety of sources, however, high quality soy bean oil appears to be a useful component in the dough of the invention. The oil is typically present in the formula in an amount from about 1 to about 10-wt %. The dough contains an increased amount of moisture relative to conventional dough and a specific controlled amount of sugar materials. Moisture is typically added to the ingredients by premixing the moisture with the ingredients and mixing the hydrated material into the dough or water can be added directly to the mixer with the dry ingredients.

Chemical leavening ingredients that can be used singly or in combination include the common chemical leaveners including sodium acid pyrophosphate, monocalcium phosphate, calcium sulfate, sodium carbonate, sodium bicarbonate and other similar materials. One important chemical leavener comprises an encapsulated sodium bicarbonate. The encapsulated nature of this material provides an extended leavening time that aids to develop the bready character in the dough as it cooks.

The dough materials of the invention can be formulated with a fiber or soluble fiber material. The benefits of fiber and soluble fiber are well known in improving health and promoting physiological properties. Fiber is known to, in some cases, reduce lipids in sensitive individuals. Both dietary fiber and soluble fibers are generally based on beta-glucan formats. The fibrous nature of soluble fibrous nature of the materials ordinarily results from the degree of branching and other molecular characteristics. Fiber can be obtained from a variety of sources and can take the form of generally cellulosic fibers, gums, soluble fibers and other forms. Carrageenan gum is one important material that can improve frozen dough charactertistics. This material is marketed under the name VISCARIN^{RXP}. Various gums are hydrocolloids can be used in formulating the doughs of the invention. Such doughs include carrageenan gums, alginate gums, xanthan gums and guar gums. Such material can be in the form of finely divided cellulosic powder or fiber, chemically modified cellulose including hydroxy alkyl cellulose, alkyl cellulose ethers such as methyl cellulose, hydroxy propyl cellulose and other food grade additive materials. Further, a number of natural gums based on cellulosic monomers can be used. Such gums include gums derived from food starch, guar gum, xanthan gum and similar materials. Other dough conditioner materials are dough additive materials can be used.

In addition, the dough can contain minor amounts of a variety of other baking additives including salt, spices, etc. The pizza can be made from a crust comprising one or more of the following: enriched wheat flour (wheat flour, niacin, reduced iron, thiamin mononitrate, riboflavin, folic acid, malted barley flour, ascorbic acid), water, yeast, contains 2% or less: soybean oil, dough conditioner (vegetable gum, sodium steroyl lactylate, soy flour, mono- and di-glycerides, dextrose, enzymes, 1-cysteine), salt, nonfat dry milk powder, baking powder (sodium acid pyrophosphate, sodium bicarbonate, monocalcium phosphate), sugar, calcium propionate added as a preservative. Other additives that can be used in the bready materials of the invention include ingredients such as fruits and vegetables, nuts, soy based ingredients and materials added to fortify the formulations. One important additive ingredient that can be used to adapt a particular bread formulation for a particular end use involves the use of selected flavorings and seasonings. Using state of the art sensory technology, flavors preferred by young persons, teenagers, gen-Xers, baby boomers or senior citizens can be formulated. Such seasonings include both sweet and savory type seasonings used in a common consumer application. Seasonings can provide dairy flavor notes such as cream-type flavors, honey-type flavors, cheesy flavors, sour cream flavors, Mexican mole sauce characters, cream cheese and other related dairy type flavors. Additional flavors can include meat flavors or fish flavors including poultry, beef, pork, clam, shrimp, scallop, etc. Additional flavors include coffee flavor (in black, cream or latte flavors), smoky flavors, vanilla, chocolate, caramel and flavors that appeal to more of an adult taste including flavors of beer, distilled spirits, anchovy, etc. Additionally, whole grains or whole grain by-products can be used in the materials of the invention. Such materials include such products and by-products as corn meal, rice, wild rice or products thereof, minor grains, tapioca, sweet potato and taro by-products.

The product can be fortified using iron preparations, bioavailable calcium sources, vitamins, minerals, amino acids and other nutraceuticals. Vitamin and vitamin-like nutritional fortification can be obtained from Vitamin E sources, beta carotine sources, L-carnitine, etc.

Formulae

| Ingredients | |
|---|---|
| % on Flour | Name |
| 100 | Flour |
| 40 to 70 | Water |
| 1 to 10 | Emulsifier |
| or | |
| 2 to 5 | |
| 0.5 to 3 | Cream Yeast (80% water) |
| 1 to 5 | Mozzarella Cheese |
| 1 to 10 | Soy Oil |
| 0.1 to 2 | Salt |
| 0.2 to 2 | Double Action Baking Powder |
| 0.2 to 5 | Natural Sweetener |
| 35 to 45 | TOTAL MOISTURE |
| 100 | Flour |
| 40 to 70 | Water |
| 0.5 to 3 | Cream Yeast (80% water) |
| 0.5 to 5 | Fiber, soluble fiber or mixtures |
| 0.2 to 5 | Food grade gum |
| 1 to 10 | Veg. (Soy) Oil or solid fat |
| 0.1 to 2 | Salt |
| 0.1 to 5 | NaHCO₃ or encapsulated |
| | NaHCO₃ |
| 0.2 to 2 | Double Action Baking Powder |
| 0.2 to 5 | Natural Sweetener (e.g.) high |
| | fructose corn syrup |
| 45 to 70 | TOTAL MOISTURE |
| 100 | Flour |
| 54 | Water |
| 2 | Salt |
| 1 | Cream Yeast (80% water) |
| 3 | Mixed monoglyceride and |
| | diglyceride Emulsifier |
| 4 | Soybean Oil |
| 3 | Mozzarella Cheese |
| 1 | Double Action Baking Powder |
| 2 | Sugar (sucrose) |
| | TOTAL MOISTURE = 35.6% |

### Mixing

The dough formulations of the invention can be formed into a useful bread product using a variety of techniques. The formulations can be conventionally mixed into a useful yeast leavened dough mixture and then formed into the desired product using conventional technologies. Such bready products can include loaves, baguettes, dinner rolls, pretzels, circular loaves, mini-loaves, rolls, hard rolls, etc. The dough of the invention can also be formed into more complex products such as pie crusts for sweet or savory pies, pizza crusts for a variety of pizza recipes, calzone products, hot pocket products and similar applications.

In manufacturing frozen pizza products that can be baked at home in a microwave oven in a short period of time to form a fully rise, bready, crispy pizza having a quality pizza dough, a number of technologies can be used. Preferred technologies include a process in which the dough are sheeted into useful pizza dough or hot pressed into useful pizza dough.

One important sheeting/cutting process for mixing the dough of the invention includes mixing dough having relatively high moisture content, specific controlled content of emulsifier, oil, and cheese. In the process of the invention, the ingredients (see the formulae above) are fed to a high-speed mixer and maintained at relatively low temperature that can range from about 75° to 85° F. The mixer is operated at high speed until a uniform mass is produced in the mixer. The mixer's content is then discharged from the mixer onto a conveyor belt. Once mixed and uniform in character and temperature, the dough is then dusted with flour and sheeted to a thickness of about 2.3 to 3 millimeters. Once sheeted, the dough is docked and cut appropriate size for the desired product. In this step, the sheet can be docked, i.e., perforated, in a random or uniform pattern with penetrating instruments either prior to or after the dough is cut into appropriately shaped sizes for the desired product. The docking step can aid in maintaining a uniform, unblistered bready character. The dough sheet is then directed to a die cutting station in which the aspect of the crust is cut into the sheeted dough. The dough of the invention can be used for bready products other than pizza crust. The dough can be formed into shapes that, after baking, can result in loaves of bread, bready dinner rolls, sweet rolls, sweet breads, pretzels, and other such products. The dough can be configured into such products using conventional shaping technology involving various aspects of sheeting, cutting, introducing score lines or areas of weakness for separation purposes.

An important hot press forming product for manufacturing the pizza doughs of the invention can be conducted by first mixing the dry ingredients with water, yeast and sweetener such as high fructose corn syrup for sufficient period of time to incorporate the materials into an initial dough ball. Once substantially uniform, fat can be incorporated into the dough ball at an appropriate speed. Care should be taken to ensure that the temperature of the dough does not exceed 80° F., preferably 72° F. Once fully incorporated with fat, the dough balls can then be formed from the dough having a weight that can range from 100 to 250 grams depending on pressed size. Once formed at the appropriate weight, the dough balls can be proofed at 90° F. and at high humidity, typically greater than 85% relative humidity for at least 15 minutes. The dough balls can have their surface incorporated with corn meal to improve crispiness in the finally baked product. The corn meal treated dough balls are then pressed using an appropriately shaped die at elevated temperatures that can range from 220° F. to 350° F. for a sufficient period to roughly shape the dough ball into a crust form. Once initially shaped, the crusts can be reshaped to achieve a final shape if necessary. The shaped crusts are then docked and brushed or sprayed with a browning agent and frozen. Once frozen, the pizza ingredients can be added to the frozen crust which can then be packaged for distribution.

The formed dough portion can be immediately topped with cheese, sauce and other toppings. Alternatively, the crusts can be packaged in multiple crust packaging and shipped to a location for topping, packaging and shipment to retail outlets. When stored and sold at a retail outlet, the pizzas are maintained in frozen condition in freezer chests before purchase. Consumers can then purchase the frozen pizzas and can maintain them at home in a frozen state until cooked. Commonly, the pizzas are then removed from conventional packaging materials and placed in consumer ovens and cooked at a microwave power setting of about 700 to about 1200 watts in a conventional microwave oven or combination microwave thermal oven for a period of time of about 2 to about 5 minutes.

The premium composition of the invention can have premium quality cheese, sauce and toppings applied to the improved crust material. A variety of typically tomato based sauces, a variety of cheeses and cheese blends can be used in combination with toppings selected from meat sources, fish sources, vegetable sources or fruit sources or other typical topping materials. Pizza sauces can include a variety of ingredients including tomato portions, tomato sauce, tomato paste, various seasonings including salt, herbs and spices.

Premium quality meats can also be applied to the pizzas of the invention. Italian sausages, pepperoni, prosciutto, seafoods such as shrimp, mussels, etc. can be used. Vegetarian pizzas can also be made including vegetables including spinach, mushrooms, onions, green peppers, etc. Fruit materials can also be used on the pizzas, both in a vegetarian and non-vegetarian form. Pineapples, apples, etc. can also be used on the pizzas of the invention. Preferred embodiments of the pizzas of the invention include Italian style pepperoni pizzas with a blended cheese topping, Italian cheese pizza having no other meat toppings but optionally including vegetable add-ons. Classic supreme pizza including pepperoni, Italian sausage, green pepper, onion, mushroom can be used. Southwest chicken formulas including grilled chicken, Mexican salsa, corn, beans and other Tejano, Mexican or Mexicano seasonings. A spinach and roasted mushroom pizza can be made using rough-cut spinach and chopped and roasted mushrooms. Lastly, a bacon and blended cheese of Italian origin including mozzarella, Parmesan, Romano can be made.

When used in a pizza product, the dough of the invention can be configured into an individual serving size portion, a serving portion that can satisfy two, three or four individuals, depending on appetite. An individual serving size portion can comprise a circular, semi-circular, oval or other variously shaped crusts having a major dimension of 6 to 8 inches with a thickness of about 3 to 6 millimeters. Such a crust can have a docking pattern of regular or random docking holes in an amount of about 1 to about 2 docking holes per square centimeter in the dough sheet. Larger pizza crusts can be obtained with similar docking hole concentration, typically in a substantially circular form having a diameter of greater than 12 inches, commonly 12 inches, 14 inches, 18 inches, etc. as desired. Such crusts can also be pre-scored or formed into crust configurations that can easily be divided into square or triangular portions for ease of consumption after baking.

### DETAILED DESCRIPTION OF THE DRAWINGS

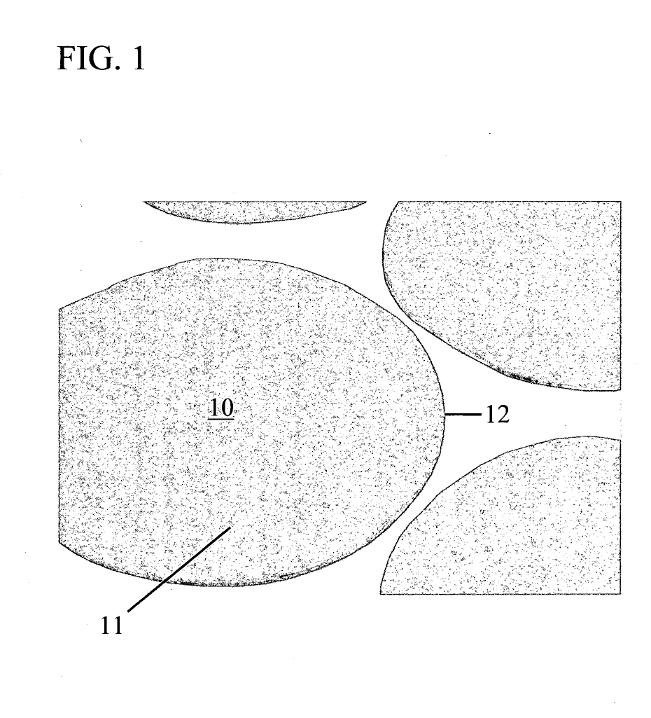

In the process of manufacturing the pizza crust of the invention, the dough formulations are blended and sheeted. The sheeted dough can then be docked and proofed to obtain a correct dough character. The dough portions 10 of FIG. 1 show the circular, uncooked, untopped pizza crusts prior to further processing. The dough 10 shows docking holes 11 and a circular “daisy-cut” edge 12. The circular crusts can be any convenient size and, once cut, docked and proofed, can be topped.

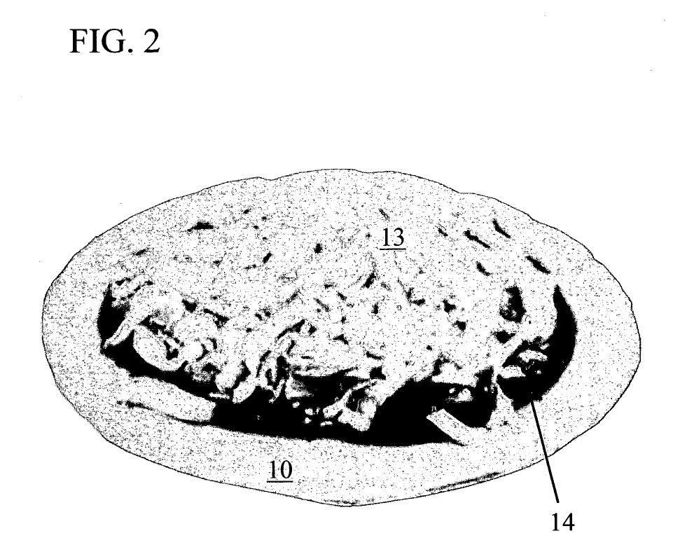

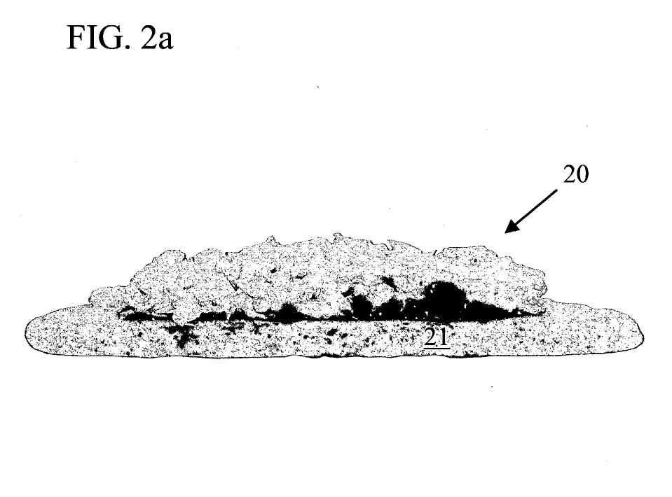

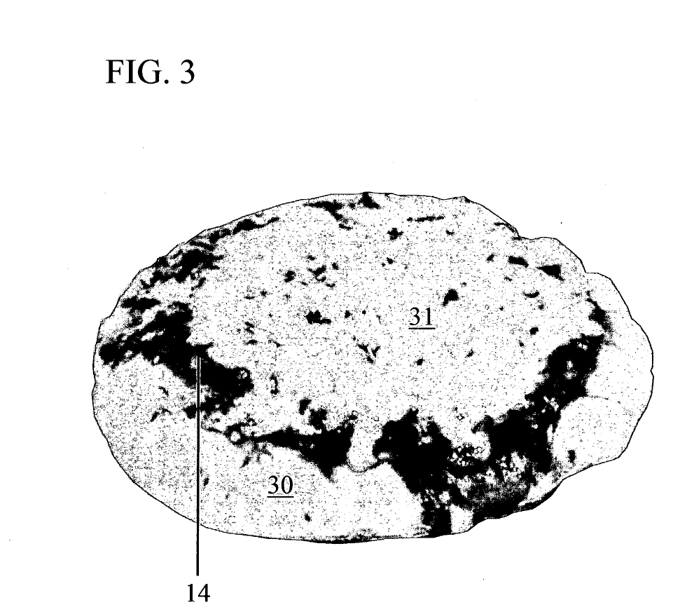

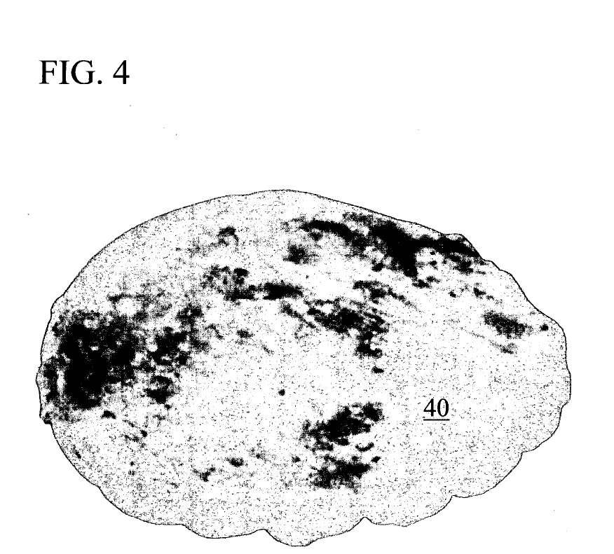

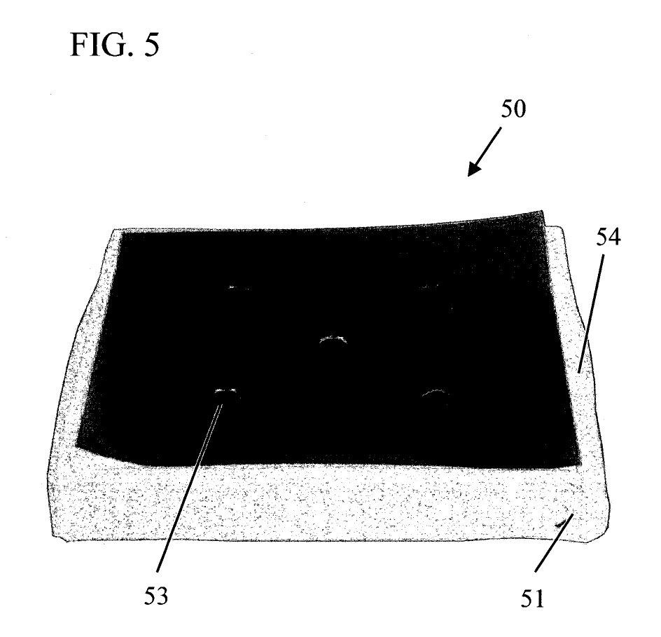

FIG. 2 shows a pizza crust 10 containing topping sauce 14 and cheese toppings 13. The assembled pizza is placed on susceptor layer (see FIG. 5) for cooking purposes. The pizza in FIG. 2 is then exposed to microwave heating for a sufficient period, typically about 120 to about 180 seconds wherein the pizza and crust reach temperatures of about 190° F. to about 210° F. During cooking, the crust expands from an initial thickness shown in crust 10 of FIG. 1 of about 4 millimeters to a final thickness of a crust shown in FIG. 3 of about 20 millimeters, a 5 fold increase in thickness. FIG. 3 additionally shows the fully cooked pizza having a fully cooked and expanded crust 30, a sauce topping 32 and cheese topping 31 in the cooked item. The pizza in FIG. 3 clearly shows a fully cooked pizza having a browned and crispy exterior crust 30. FIG. 4 shows the reverse or bottom side 40 of the pizza crust of FIG. 3. The bottom 40 of the crust 30 is clearly browned, crispy and appealing to consumers.

In the process of manufacturing the pizza crust of the invention, the dough formulations are blended and sheeted. The sheeted dough can then be docked and proofed to obtain a correct dough character. The dough portions 10 of FIG. 1 show the circular, uncooked, untopped pizza crusts prior to further processing. The dough 10 shows docking holes 11 and a circular “daisy-cut” edge 12. The circular crusts can be any convenient size and, once cut, docked, proofed and frozen can be topped.

FIG. 2 shows a pizza crust 10 containing topping sauce 14 and cheese toppings 13. The assembled pizza is placed on susceptor layer 15 for cooking purposes. The pizza in FIG. 2 is then exposed to microwave heating for a sufficient period, typically about 120 to about 180 seconds wherein the pizza and crust reach temperatures of about 190° F. to about 210° F. During cooking, the crust expands from an initial thickness shown in crust 10 of FIG. 1 of about 4 millimeters to a final thickness of a crust shown in FIG. 3 of about 20 millimeters, a 5 fold increase in thickness.

FIG. 2a shows a cross section of the pizza crust of FIG. 2. In FIG. 2, the interior of the crust 10 is shown. The thickness of this layer is less than about 5 millimeters. In comparison to the fully cooked crust of FIG. 3, the degree of expansion of the raw crust of FIG. 2a to the fully cooked crust of FIG. 3 is readily apparent.

Further, the change in the character of the cooked crust is marked by a substantial rising, creation of a raised, leavened bread characteristic of a tender bread can be noted when comparing the thin, relatively solid nature of the uncooked dough to the expanded, raised, cellular crumb nature of the fully cooked baked crust in FIG. 3. FIG. 3 additionally shows the fully cooked pizza having a fully cooked and expanded crust 30, a sauce topping 32 and cheese topping 31 in the cooked item. The pizza in FIG. 3 clearly shows a fully cooked pizza having a browned and crispy exterior crust 30.

FIG. 4 shows the reverse or bottom side 40 of the pizza crust of FIG. 3. The bottom 40 of the crust 30 is clearly browned, crispy and appealing to consumers. Moisture control in the dough and cooked crust of the invention is an important criterion. The interaction between the dough and the susceptor layer during cooking is an aspect that aids in moisture control. We have found that the accumulation of substantial moisture between the crust and the susceptor can reduce crust quality. Also, we have found that in certain instances, conventional susceptor can overheat the crust resulting in areas of reduced moisture and increased toughening.

The susceptor 50 shown in FIG. 5 is a susceptor, developed for pizza crust microwave baking that is adapted to reduce overheating while maintaining correct moisture content. In FIG. 5 is shown a susceptor 50 with a susceptor layer 52 layered on a support surface 54. The support surface 54 is maintained above the bottom of the microwave oven chamber by a box support 51 that provides an enclosed volume (not shown) under the support surface 54 surrounded by the support 51. This chamber or volume provides an escape route for moisture leaving the bottom of the cooking crust, but maintains the moisture within the cavity, thus helping maintain adequate and moisture content in the crust. The susceptor 52 is sized to include on the susceptor surface, in contact between the crust and the susceptor surface, entirely the crust of the invention. Accordingly, this susceptor surface is sized such that it is at least marginally greater in size than the major dimension of the pizza crust. In other words, the susceptor layer is sized such that the pizza crust, regardless of its size or shape, is in contact with some proportion of the susceptor over the entire area of the bottom of the crust. The apertures 53 formed in the susceptor layer 52 aid in modulating the amount of heat generated in response to the microwave power. We have found that cooking the pizza as uniformly as possible reduces the tendency of the central portion of the crust to overheat and toughen. Accordingly, approximately 0.5 to 0.7% of the area of the susceptor is removed through the introduction of apertures into the susceptor surface. We have found that the careful placement of two, three, four, five or more apertures in an even pattern over the susceptor surface can aid in obtaining adequate moisture control.

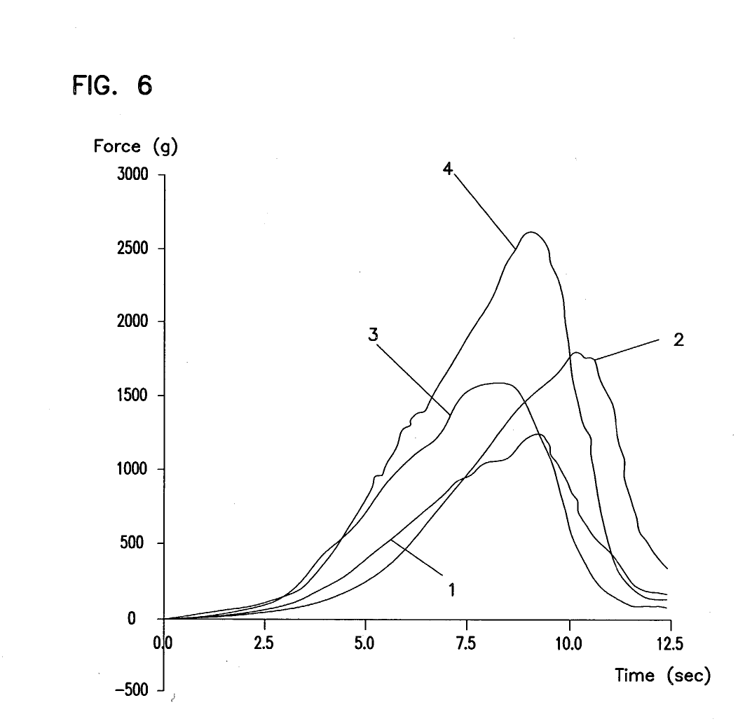

FIG. 6 is a graphical representation of the crust lip and interior crumb physical properties of the crust made with the formula of Example 1.

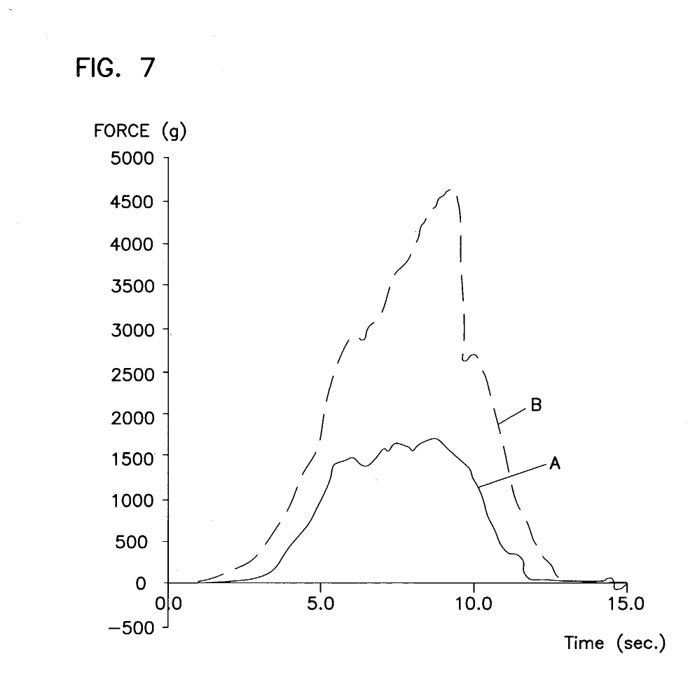

FIG. 7 is a graphical representation of the data in the table relating to the Example 5 and its comparative material.

### EXPERIMENTAL EXAMPLES

### Example 1

The platform is a single serving 6-inch unit produced from raw dough, then frozen; topped and packaged. The product cooks in the microwave in 2½ to 3 minutes depending on the oven power. Microwave cooking employs a basic susceptor perforated to allow for even energy distribution in the bottom of the crust, while producing a crisp texture and the desired crumb cell structure.

Dough Formula
Daisy shaped die with crimp edge. 6 inch disc weight 105 g ± 5 grams

| | |
|---|---|
| Un-malted spring flour (ADM) | 100 |
| Water (room temp. 75 ± 5° F. | 54 |
| Salt | 2 |
| Sugar | 2 |
| Emulsifier mixed Mono/Di- | 3 |
| Glyceride - PH300K-A | |
| DANIS COCULTOR | |
| Soybean Oil | 4 |
| Yeast (instant active) | 1 |
| Double Action Baking Powder | 1 |
| Mozzarella Cheese (shredded) | 3 |
| Total dough weight | 170.0 |

Process: Mix all ingredients with spiral dough hook on low speed for 2 minutes, then 6 minutes on high speed. Dough temperature after mix is 75±5° F. Rest the dough for 15 minutes (about the time needed for transfer dough from mixer to sheeting rollers on the line). The dough is sheeted to a final thickness of 2-3 mm and is docked. The stress free sheeting system consists of 12 steps. The sheeted dough is then die cut using DAISY 6 inch circles. The DAISY die shaped crust is then proofed in trays at 90° F. temperature and 95% humidity for 45 minutes. Under proof creates a dense cell structure and over proof reduces the raise of cooked product. Freeze proofed dough in blast freezer to −20° F. Coat frozen product by dipping in or spraying with 50% V/V or W/W Aqua's mailose solution (Red Arrow, Wis.). Top with sauce and cheese and package the frozen product. Store the final product at −20° F.

### Example 2

Dough

| | |
|---|---|
| Crust (wt.) | 100.00 |
| Flour | 55.88% |
| Water | 30.18% |
| Caramel color | 5.00% |
| Soybean oil | 2.24% |
| Mozzarella cheese | 1.68% |
| Mono and diglyceride | 1.68% |
| emulsifier | |
| Baking Powder | 1.12% |
| Salt | 1.12% |
| Sugar | 0.56% |
| Yeast | 0.56% |
| | 100.02% |

Sauce

| | |
|---|---|
| Sauce (wt.) | 30.00 |
| Tomatoes | 93.94% |
| Parmesan cheese | 1.72% |
| Sugar | 1.36% |
| Salt | 1.20% |
| Corn oil | 0.84% |
| Spices | 0.78% |
| Garlic | 0.15% |
| | 99.99% |

Cheese Blend

| | |
|---|---|
| Cheese Blend (wt.) | 45 |
| LMPS Mozzarella | 67.64% |
| Cheddar yellow | 16.91% |
| Provalone, smoked | 10.14% |
| Parmesan | 5.07% |
| Parsley flakes | 0.24% |
| | 100.00% |

Cooking instruction: Cook the food from a frozen state. Use a microwave oven at a power setting of 800 W or higher. Unwrap pizza, place susceptor tray in microwave, gray silver side up. Place the frozen pizza on top of the susceptor tray. Cook on 100% power for microwaves 800 W to 1000 W for 2½ to 3 minutes. Cook on 100% power for microwaves higher than 1000 W for 2 to 2½ minutes. Let the pizza rest for a minute before handling.

### Example 3a-3g

| Ingredient | 3a | 3b | 3c | 3d | 3e | 3f | 3g |
|---|---|---|---|---|---|---|---|
| Flour | 3000 g (100%) | 3000 (100%) | 25 lb (100%) | 4000 g (100%) | 4000 | 4000 | 3000 |
| water | 1470 g (49%) | 1380 (46%) | 14 lb (56%) | 2160 g (54%) | 2160 | 2160 | 1620 |
| Salt | 24 g (0.8%) | 30 (1%) | 0.25 (1%) | 80 g (2%) | 80 | 80 | 60 |
| Sugar | 60 g (2%) | 30 (1%) | 0.5 (2%) | 80 g (2%) | 80 | 80 | 60 |
| monoglyceride/diglyceride | 300 g (10%) | 150 (5%) | 0.75 (3%) | 40 g (1%) | 80 (2%) | 80 | 60 |
| Emulsifier | | | | | | | |
| Yeast | 9 g (0.3%) | 15 (0.5%) | 0.125 (0.5%) | 40 g (1%) | 40 (1%) | 40 | 30 |
| Encapsulated NaHCO₃ | 75 g (5.25%) | 60 (2%) | 0.25 (1%) | — | — | — | — |
| DBL Action BP | 30 g (1%) | 60 (2%) | 0.25 (1%) | 80 g (2%) | 80 | 80 | 60 |
| Carageenan | 0-60 g (<2%) | | 0.25 | | | | |
| Bread Flour | 30 g (1%) | | 0.25 | | | | |
| Corn Meal | 60 g (2%) | — | | | | | |
| Viscarin XP 3410 | 9 g (0.3%) | 12 g | 0.1 (4%) | 12 g (0.3%) | 12 (0.3%) | | |
| All Purpose Entry | | 150 g | 0.75 (3%) | | | | |
| Sugar at BP | | | 0.28 (1%) | | | | |
| Acid leavening blend | | | 0.5 | | | | |
| Soy oil | | | | 120 g (3%) | 160 (4%) | 160 | 120 |
| Single Action Baking Powder | | | | 80 g (2%) | 80 (2%) | 80 | 60 |
| Mozzarella | | | | 200 g (5%) | — | 80 | 90 |
| Parmesan | | | | — | — | 40 | 30 |

In our experimental work, we have found that the combination of emulsifier in the increased amounts and the cheese used in the formulations results in an improved crust. The physical properties of the crust and the taste panel data show that these crusts are statistically different from crusts not containing the claimed emulsifier and cheese components. In the test data Examples 1, 2, 3d, 3f and 3g having the emulsifier and cheese had the best-baked bread character, best tender bread, best crispness in a browned crust and excellent raised character.

TABLE
CRUST PROPERTIES-EXAMPLE 1 - SHOWN IN FIG. 6

| Sample | Force | Force Gradient | Area of Force Curve |
|---|---|---|---|
| Location | (grams) | (gm/sec) | (gm-sec) |
| Crumb + 5 | 1269.625 | 136.092 | 4261.219 |
| Lip + 5 | 1614.183 | 200.36 | 4687.477 |
| Crumb + 20 | 1817.852 | 176.463 | 5862.551 |
| Lip + 20 | 2664.995 | 294.449 | 7915.735 |

A pizza, with a crust made according to Example 1, was baked as described above. The crust was measured for its physical properties. The data shown in the graph of FIG. 6 demonstrates the difference in force required to penetrate the lip at the edge of the crust and the crumb in the center of the crust. The lip should be crispy but is representative of the areas susceptible to microwave toughening while the central crumb is bready but can be overcooked and can toughen. The crumb curves 1 and 2 show that the crumb reaches a force level of 1270 grams at +5 minutes post-cook and 1818 grams at +20 minutes post-cook. The lip curves 3 and 4 show that the lip reaches a force level of 1614 grams at +5 minutes post-cook and 2665 grams at +20 minutes post-cook. These levels are characteristic of a bready and crisp dough without toughening and having the desired characteristics of the invention.

### Example 4

| | % on | | |
|---|---|---|---|
| Ingredient | Flour | Wt. (g) | Ingredient Information |
| Unmalted flour | 100 | 1000 | Dominator hard spring wheat - |
| | | | 13% Protein - ADM Milling - |
| | | | No. Kansas City, MO |
| H₂O | 56.42 | 564 | Water |
| Yeast | 2.40 | 24 | Yeast |
| High fructose corn | 6.309 | 63 | High fructose corn syrup |
| syrup | | | |
| Salt | 2 | 20 | |
| Uldo (Opti-Frost) | 2 | 20 | DATEM, wheat gluten, sugar, |
| | | | dextrose, wheat flour, guar |
| | | | gum, active malt flour, calcium |
| | | | pyrophosphate, lecithin, |
| | | | ascorbic acid, enzyme |
| Chemical leavening | 2 | 20 | Sodium acid pyrophosphate, |
| | | | monocalcium phosphate, |
| | | | calcium sulfate |
| NaHCO₃ | 1 | 11.8 | Encapsulated sodium |
| | | | bicarbonate - Sample, Lt # |
| | | | 3893GV Baichem Corporation, |
| | | | P.O. Box 175, Slate Hill, NY |
| | | | 10973 (877) 222-881 (toll-free) |
| Cellulose fiber | 1 | 10 | Cellulose |
| Gum | 1 | 10 | Food starch, guar gum, xanthan |
| | | | gum |
| HPMC | 0.6 | 6 | Hydroxypropyl methylcellulose |
| Dough conditioner | 0.075 | 0.75 | Sweet dairy whey, ammonium |
| | | | sulfate, Ly-cysteine |
| DATEM | 0.1 | 1 | Diacetal tartaric acid ester of |
| | | | monodiglycerides |
| Emulsified | 2.4 | 24 | Partially hydrogenated soy and |
| shortening (Crisco) | | | cottonseed oils, mono and |
| | | | diglycerides |
| Pastry flakes | 3.6 | 36 | Chilled - Delayed Addition - |
| | | | Lite pastry flakes (40% |
| | | | nitrogen) w/salt/lightly - Inland |
| | | | Products, Inc. |

First, the dry ingredients were combined and then combined with water, yeast and high fructose corn syrup as shown inn the formula of Example 4. The mixture is blended until uniform and then the pastry flakes are then added and blended until uniform. Care is taken to maintain the dough temperature at about 68° F. to 70° F. The batch was divided into dough balls of 130 grams each. The dough balls were proofed for 15 minutes at 90° F. and 90% relative humidity until ready. The dough balls were then treated with corn meal to improve surface crispiness and then hot pressed to form a 6 inch pizza crust at a 6 second dwell time 500 lbs. pressure pressing conditions using 225 F top heat, 300 bottom. The formed crusts were then docked, brushed with browning agent and frozen before topping.

After freezing, the frozen crusts were topped with 40 grams of pizza sauce, 10 grams of diced pepperoni, 32 grams of a blend of American and mozzarella cheese (25%/75%) and 8 grams quartered pepperoni. The frozen products were baked in a microwave oven at 700 watts for 5 minutes using a susceptor substantially identical to that shown in FIG. 5. The resulting pizza was fully cooked, showed a crispy exterior, a bready interior and had no microwave toughening characteristics.

### Example 5 and Comparative Preparation 5

Example 4 was substantially repeated as shown and tested on the texture analyzer as discussed above. Example 5 was repeated, as Comparative Preparation 5, with neither the high fructose corn syrup, chemical leavening, HO-propyl-cellulose starch/gum and emulsifier nor fat flakes. The resulting dough were baked, and tested on the texture analyzer as discussed above without toppings.

CRUST PROPERTIES-EXAMPLE 5 and Comparative
Preparation 5 (SHOWN IN FIG. 7)

| | Force | Force Gradient | Area of Force Curve |
|---|---|---|---|
| Test Location | (grams) | (gm-sec) | (gm-sec) |
| Example 5 | 1,714 | 192 | 6,881 |
| Comparative 5 | 4,659 | 494 | 17,308 |

The texture results from the Comparative Preparation 5, including the peak height and force curve area show a significantly larger value, indicating a tougher, chewier product. The basic formula of Example 5 showed a lower Force and Area of force curve indicating softer crisper dough. Comparative Preparation 5 also had a steeper force gradient, but in this case this result reflects the much higher peak force of a tough material and not necessarily a crisper product.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A dough that can be baked in a microwave oven, the dough comprising a yeast leavened mixture comprising a major proportion of flour, about 30-60 wt % water and about 1-10 wt % of a cheese, the percentages based on flour content, wherein the dough after baking results in a substantially uniformly raised, tender, bready interior with a crisp, browned crust wherein the crust crispness is characterized by a curve showing penetration force, a peak force of less than 3000 g and a bready tenderness characterized by a penetration force, measured by the area under the force curve, of less than 5500 gm-sec.

2. The crust of claim 1 comprising about 1-10 wt % emulsifier.

3. The crust of claim 1 comprising about 0.5 to 5 wt % of fiber, soluble fiber or mixtures thereof, 0.1 to 2 wt % of a gum and about 2 to 8 wt % of a blend of an oil and a room temperature solid fat.

4. The dough of claim 1 wherein the moisture content of the formulated dough comprises about 35 to 55 wt. % and the moisture content of the final baked bread or crust comprises about 25 to 35 wt.-%.

5. The dough of claim 1 wherein the dough has the capacity to raise to a ratio of initial thickness:final thickness of about 1:2 to about 1:10 in the substantial absence of microwave toughening wherein the dough reaches maximum extent of raise in less than 200 seconds.

6. The dough of claim 1 wherein the peak force is about 1250 to 3000 g and the area under the force curve is greater than 8000 gm-sec.

7. The dough of claim 1 wherein the slope of the force curve is greater than 550 gm-sec⁻¹.

8. The dough of claim 7 wherein the emulsifier comprises a blend of monosubstituted glycerin and disubstituted glycerin, the glycerin substituted with a fatty acid moiety.

9. The dough of claim 1 that additionally contains about 0.1 to 5 wt % of a natural sweetener.

10. The dough of claim 9 wherein the sweetener comprises sucrose, dextrose, high fructose corn syrup or mixtures thereof.

11. The dough of claim 2 comprising about 1.5 to 8 wt % of a food grade emulsifier and 1 to 10 wt.-% oil.

12. The dough of claim 1 wherein the cheese comprises a cheese blend.

13. The dough of claim 1 additionally comprising about 0.04 to 0.05 wt % of a browning agent.

14. The dough of claim 1 wherein the dough comprises about 0.1 to 0.3 wt % of a natural gum.

15. The dough of claim 14 wherein the natural gum comprises a carrageenan gum.

16. The dough of claim 1 additionally comprising a chemical leavening agent.

17. The dough of claim 16 wherein the chemical leavening agent comprises bicarbonate-leavening agent.

18. The dough of claim 16 wherein the dough comprises about 1 to 2-wt % of a baking powder.

19. The dough of claim 18 wherein the baking powder comprises a single acting baking powder, a double acting baking powder, or mixtures thereof.

20. A dough that can be baked in a microwave oven, the dough comprising a yeast leavened mixture comprising a major proportion of flour, about 30 to 65 wt % water, about 0.1 to 10 wt % of a food grade emulsifier, about 1 to 15 wt % of a cheese and 4 to about 15 wt % of a fat, the percentages based on flour content, wherein the dough after baking results in a fully raised, tender, bready interior with a crisp browned crust.

21. The dough of claim 20 wherein the crust crispness is characterized by a curve showing penetration force, a peak force of less than 3000 g and a bready tenderness characterized by a penetration force, measured by the area under the force curve, of less than 5500 gm-sec.

22. The dough of claim 20 wherein the dough reaches maximum extent of raise in less than 200 seconds.

23. The dough of claim 20 wherein the moisture content of the formulated dough comprises about 35 to 50 wt. % and the moisture content of the final baked bread or crust comprises about 25 to 35 wt.-%.

24. The dough of claim 20 wherein the dough has the capacity to raise to a ratio of initial thickness:final thickness of about 1:2 to about 1:10 in the substantial absence of microwave toughening.

25. The dough of claim 20 that additionally contains about 0.1 to 5 wt % of a natural sweetener.

26. The dough of claim 20 wherein the dough comprises about 1 to 2 -wt % of an encapsulated NaHCO₃.

27. The dough of claim 30 wherein the baking powder comprises a single acting baking powder, a double acting baking powder, or mixtures thereof.

28. A dough that can be baked in a microwave oven, the dough comprising a yeast leavened mixture comprising a major proportion of flour, an effective amount of a chemical leavening agent, about 30 to 65 wt % water, about 5 to 50 wt % of a fiber, a soluble fiber, or natural gum and 4 to about 15 wt % of a fat, the percentages based on flour content, wherein the dough after baking results in a fully raised, tender, bready interior with a crisp browned crust.

29. The dough of claim 28 wherein the crust crispness is characterized by a curve showing penetration force, a peak force of less than 3000 g and a bready tenderness characterized by a penetration force, measured by the area under the force curve, of less than 5500 gm-sec.

30. The dough of claim 28 wherein the dough reaches maximum extent of raise in less than 200 seconds.

31. The dough of claim 28 wherein the moisture content of the formulated dough comprises about 35 to 50 wt. % and the moisture content of the final baked bread or crust comprises about 25 to 35 wt.-%.

32. The dough of claim 28 wherein the dough has the capacity to raise to a ratio of initial thickness:final thickness of about 1:2 to about 1:10 in the substantial absence of microwave toughening.

33. The dough of claim 28 that additionally contains about 0.1 to 5 wt % of a natural sweetener.

34. The dough of claim 28 wherein the dough comprises about 1 to 2-wt % of an encapsulated NaHCO₃.

35. The dough of claim 34 wherein the baking powder comprises a single acting baking powder, a double acting baking powder, or mixtures thereof.

36. A method of making a frozen pizza that can be baked in a microwave oven to a pizza having a browned crust with a crispy exterior and a bready interior, the process comprises forming a dough comprising the dough of claim 20, forming a dough ball comprising a dough mass of about 100 to 250 grams, pressing the dough ball into a rough pizza form and freezing the pizza form before adding pizza toppings.

37. A method of making a frozen pizza comprising the steps of forming the dough of claim 29, sheeting the dough into a dough sheet having a thickness of about 0.5 to 10 millimeters, proofing the dough sheet to form a proofed sheet, cutting the proofed sheet into pizza forms and topping the pizza forms.

38. The dough of claim 1 wherein the slope of the penetration curve is greater than 300 gm-sec⁻¹.

39. The dough of claim 20 wherein the slope of the penetration curve is greater than 300 gm-sec⁻¹.

40. The dough of claim 28 wherein the slope of the penetration curve is greater than 300 gm-sec⁻¹.
